(19) United States
(12) Patent Application Publication
(10) Pub. No.: US 2010/0137757 A1
(43) Pub. Date: Jun. 3, 2010

(54) Zeleny therapeutic sonosphere

(76) Inventor: Charles Timberlake Zeleny, Baltimore, MD (US)

Correspondence Address: DUANE MORRIS LLP, Suite 1000, 505 9th Street, N.W., Baltimore, MD, 20004, US

(21) Appl. No.: 12/292,949

(22) Filed: Dec. 1, 2008

(51) Int. Cl. A61H 23/00

(52) U.S. Cl. 601/47

(57) ABSTRACT

Inverse speaker systems comprise a plurality of individual sound-reproducing elements arranged in a substantially spherical arrangement. These inverse speaker systems are useful for applying sound to a human body for therapy.

### FIELD OF THE INVENTION

The present invention relates to an apparatus for applying omnidirectional sound to a human body for therapy.

### BACKGROUND OF THE INVENTION

There are presently a number of methods and techniques for the treatment of cancer, among which may be included: radiation therapy, chemotherapy, immunotherapy, and surgery. The common characteristic for all of these techniques, as well as the vast majority of other currently known techniques, is that they are extracellular in scope, i.e. the cancer cell is attacked and attempted to be killed through application of a killing force or medium outside of the cell.

Similarly approaches have been taken with respect to other potential biological contaminants that affect humans, such as viruses and bacteria. That is, to date, the vast majority of therapeutic techniques have focused on attacking and destroying the biological contaminant through application of some external agent, such as an antibiotic or antiviral drug.

The extracellular approach is found to be less effective because of the difficulties of penetrating the biological contaminant. For example, a cancer cell is surrounded by a membrane composed of two protein layers with a lipid layer in between. Bacteria are similarly surrounded by a cell membrane, which, in turn, is surrounded by a peptidoglycan cell wall. Viruses are surrounded by a capsid, a tough protein shell.

Of even greater significance when using an extracellular approach is that in order to overcome the protection afforded the cell membrane/cell wall/capsid, the attack must be of such intensity that considerable damage is frequently caused to the normal cells, which in turn causes potentially severe side effects in the patient. These side effects have frequently been found to limit the effectiveness and usefulness of extracellular treatment of biological contaminants in a human body.

Safe and effective treatments of biological contaminants have been the goal of many researchers and investigators for a substantial period of time. To be successful, such techniques should be completely selective, and permanently affect only the biological contaminant and not the normal cells. In sum, such a treatment must selectively differentiate the biological contaminant from normal cells and must selectively weaken or kill the biological contaminant without concomitant damage to the normal cells.

### SUMMARY OF THE INVENTION

It is therefore an object of the present invention to provide an apparatus that overcomes some or all of the problems associated with known devices and treatments. Other objects, features and advantages of the present invention will be set forth in the detailed description of preferred embodiments that follows, and in part will be apparent from the description or may be learned by practice of the invention. These objects and advantages of the invention will be realized and attained by the apparatus and methods particularly pointed out in the written description and claims hereof.

In accordance with these and other objects, a first embodiment of the present invention is directed to an apparatus for the therapeutic application of sound waves to a human body. Such an apparatus comprises an inverse speaker system operably connected to an adjustable external support frame. The inverse speaker system comprises a plurality of individual sound-reproducing elements having a substantially spherical arrangement defining a cavity having a diameter sufficient to accommodate at least one human body without said body contacting any of said sound-reproducing elements. The external support frame holds the inverse speaker system in a particular orientation relative to the external environment, particular with respect to one or more external magnetic flux lines. Optionally, the apparatus may also include a motor for changing the position of the inverse speaker system relative to the external environment.

A second embodiment of the present invention is directed to a method of treating a human body to reduce the level of a biological contaminant, such as a virus or a neoplastic cell. This method involves placing a human inside an apparatus as described above and then subjecting said human to sound waves having at least one frequency characteristic of the biological contaminant but not characteristic of normal cells, for a time sufficient to disrupt the biological contaminant.

It is to be understood that both the foregoing general description and the following detailed description are exemplary and explanatory only and are intended to provide further explanation of the invention as claimed.

### DESCRIPTION OF THE DRAWINGS

The invention will be more readily understood from a non-limiting description of certain preferred embodiments that follows and from the diagrammatic figure of the drawings.

FIG. 1 shows a schematic diagram of one embodiment of the present invention (Zeleny Sonosphere CE-302B).

### DETAILED DESCRIPTION OF THE PREFERRED EMBODIMENTS

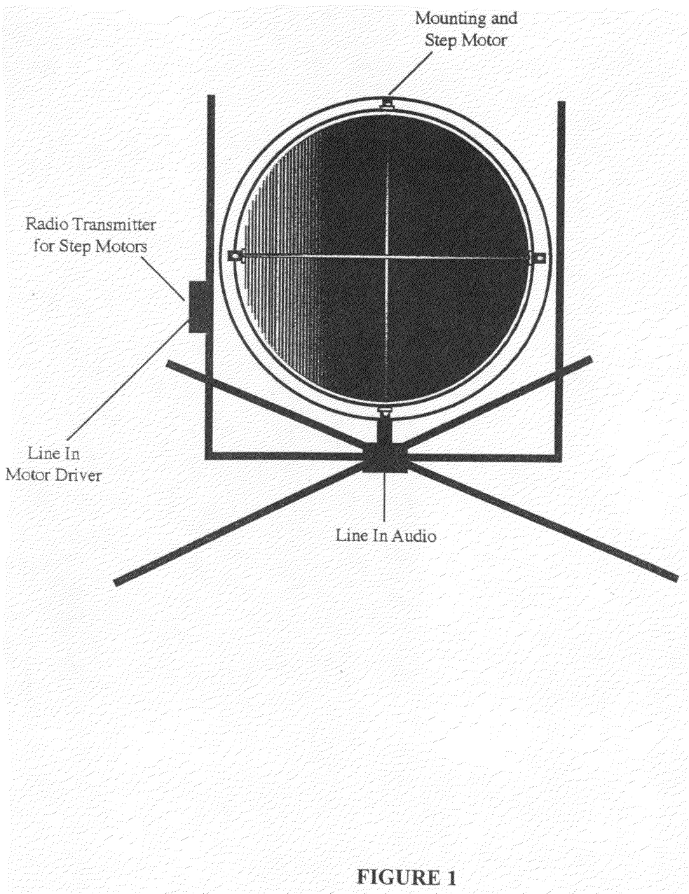

Referring now to FIG. 1, there is shown a schematic diagram for one embodiment of the present invention. As shown in FIG. 1, this preferred embodiment comprises a plurality of individual sound-reproducing elements connected to one another in a substantially spherical arrangement defining a cavity. This cavity is large enough to accommodate at least one human body without it touching any of the sound-reproducing elements. According to certain embodiments, the diameter of the substantially spherical arrangement will be sufficient to accommodate a human adult in a standing position, e.g. a diameter of at least 3 meters, while according to other embodiments, the diameter will only be sufficient to accommodate a human child in a standing position or a human adult in a sitting position, e.g. a diameter of about 2 meters. According to still other embodiments, the diameter will only be sufficient to accommodate a human infant or a human child in a sitting position, e.g. a diameter of about 1 meter.

The individual sound-reproducing elements may be any suitable sound-reproducing structure known and available to those skilled in the art. Suitable sound-reproducing structures, and means for connecting and operating the same, are described, for example, in the following: U.S. Pat. No. 3,636,278 to Heil for “Acoustic Transducer with a Diaphragm Forming a Plurality of Adjacent Narrow Airspaces Open Only at One Side with Open Sides of Adjacent Air Spaces Alternatingly Facing in Opposite Directions”; U.S. Pat. No. 4,056,697 to Heil for “Movable Diaphragm Connector Method Flexible Hinge Diaphragm Surround and Electro-Acoustic Transducer with Folded Diaphragm with Intermediate Positions”; U.S. Patent Application Publication No. US 2004/0052386 to Heron for “Panel Form Loudspeaker”; and U.S. Patent Application Publication No. 2004/0066938 to Heron for “Loudspeaker”. The disclosures of each of these documents is hereby expressly incorporated by reference.

According to certain preferred embodiments of the present invention, the individual sound-reproducing elements may be in the shape of individual strips, each of which comprises a plurality of at least partly vibratory diaphragm portions arranged to define between themselves adjacent narrow airspaces. The strips are connected in such a way that the adjacent airspaces are alternatingly closed and left open at opposite ends. Such strips are preferably long enough to reach from one pole of the inverse speaker system to the other pole. Alternatively, the strips may reach from a pole of the inverse speaker system to the mid-point, or equator, of the substantially spherical arrangement. Each strip also includes means for transforming vibrations imparted thereto by electric energy into sound waves. The strips are connected to one another in such a manner as not to interfere with the production of sound waves thereby. Suitable connecting means are known in the art.

According to other preferred embodiments of the present invention, the individual sound-reproducing elements may be in the form of pentagonal and hexagonal panels. Such panels may be of any suitable size and dimension, and are preferably arranged in a geometric, “buckyball” fashion. Each of these panels has at least one electro-mechanical drive means coupled thereto to excite a multi-modal resonance in said panel in response to an electrical input within a working frequency band for the inverse speaker system. Each panel is held in place by mounting means, which supports the panel and/or attaches the panel to a supporting body in a free undamped manner. Suitable mounting means are known in the art.

According to still other preferred embodiments of the present invention, the individual sound-reproducing elements are panels in the shape of hemi-spherical shells. Each of these panels also has at least one electro-mechanical drive means coupled thereto to excite a multi-modal resonance in said panel in response to an electrical input within a working frequency band for the inverse speaker system and each panel is held in place by suitable mounting means.

Regardless of the shape selected, the individual sound-reproducing elements must be arranged such that a human can enter and leave the internal cavity defined by the individual sound-reproducing elements. The particulars of such will depend on the specific shape(s) employed and so can be determined empirically by one skilled in the art. For example, if the individual sound-reproducing elements are in the shape of individual strips extending from one pole to the other, provision can be made to permit the separation of two strips by a distance sufficient to permit a human to enter the internal cavity of the substantially spherical arrangement, such as by providing one or more hinges along an outer edge of the substantially spherical arrangement. Alternatively, if the individual sound-reproducing elements are in the shape of panels, one or more panels may be arranged to be movable to permit a human to enter the internal cavity of the substantially spherical arrangement.

The inventive inverse speaker system is substantially spherical, i.e. points on the surface of the inverse speaker system will all be substantially the same distance from a fixed point. Preferably, all points on the surface of the inverse speaker system will be within 10% of a predetermined distance from a fixed point within the internal cavity defined by the sphere. More preferably, all points on the surface will be within 5% of a predetermined distance from a fixed point within the sphere, and even more preferably within 2%. Still even more preferably, all points on the surface will be within 1% of a predetermined distance from a fixed point within the sphere, and most preferably within 0.1%.

According to preferred embodiments of the present invention, the inventive inverse speaker system further comprises means for supporting a human body within the internal cavity of the substantially spherical arrangement.

Referring again to FIG. 1, a suitable support may be in the shape of a chair or stool large enough to support the user. The support must be of sufficient strength to remain substantially rigid when subjected to the user's weight. Examples of materials that can be used for the support include, but are not limited to, wood, sound board, plywood, particle board, composite insulation board, plastic, glass, Plexiglas, fiberglass, metal, stone, marble, etc.

The present invention also preferably includes at least one sound generator having plurality of outputs connected to the individual sound-reproducing elements. The sound generator may be any sort of device that generates an electrical output which may be converted into acoustic vibrations. Examples of some types of sound generators include, but are not limited to, stereo systems, radio receivers, phonographs, compact disc players, tape recorders and players, cable box decoders, satellite signal capturing devices, televisions, video cassette recorders, Internet connecting devices, etc. The sound generator may also include either an internal or external amplifier.

Controls for the sound generator may be accessible to the user inside the internal cavity or may be controlled by someone outside. Most preferably, each individual sound-reproducing element may be controlled using a separate control. These controls may be either a specifically designed device or a general purpose computer employing a software program to regulate delivery of the frequency vibrations to the user.

According to certain preferred embodiments, the inverse speaker system of the present invention emits acoustic vibrations in a range that will adversely affect the biological contaminant in the human patient without concomitant permanent damages to the normal cells of that patient. Suitable frequency ranges will vary depending upon the specific biological contaminant(s) being treated, and can be determined empirically by one skilled in the art. Preferred frequency ranges are those that include at least one resonant frequency uniquely associated with the biological contaminant being treated. For example, if the biological contaminant is a virus, the frequency employed will generally lie in the range of from 1 GHz to 300 GHz, but higher frequencies may also be used.

Referring again to FIG. 1, the inventive apparatus also includes an adjustable external support frame which can position the plurality of individual sound-reproducing elements in any desired orientation with respect to the external environment. Optionally, such an apparatus may also include a motor for changing the position of the sound-reproducing elements of the inverse speaker system relative to the external environment. According to certain particularly preferred embodiments, the external support frame is a gyroscope.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. An apparatus for treating a human body with sound, said apparatus comprising: (i) an inverse speaker system comprising a plurality of individual sound-reproducing elements having a substantially spherical arrangement defining a cavity having a diameter sufficient to accommodate at least one human body without said body contacting any of said sound-reproducing elements; and (ii) an external frame for positioning said inverse speaker system relative to the external environment.

2. The apparatus according to claim 1, further comprising at least one motor operably connected to said adjustable external support frame for mechanically adjusting the position of said inverse speaker system in a desired orientation with respect to the external environment.

3. The apparatus according to claim 1, wherein said external support frame comprises a gyroscope.

4. The inverse speaker system according to claim 1, wherein each of said plurality of individual sound-reproducing elements comprises a plurality of closely spaced, partially vibratable diaphragm portions arranged substantially parallel to one another and defining between themselves narrow airspaces; and means connected to each of said vibratable diaphragm portions closing each of said airspaces all around with the exception of one side which remains acoustically open, wherein said open sides of adjacent airspaces face in opposite directions.

5. The inverse speaker system according to claim 1, wherein each of said plurality of individual sound-reproducing elements comprises a panel of suitable dimension and stiffness and at least one electro-mechanical drive means coupled to said panel to excite a multi-modal resonance in said panel in response to an electrical input within a working frequency band for said inverse speaker system.

6. The inverse speaker system according to claim 5, further comprising mounting means which supports said panel and/or attaches said to a supporting body in a free undamped manner.

7. The inverse speaker system according to claim 1, further comprising means for supporting a user within the internal cavity of said substantially spherical arrangement.

8. A method for reducing the level of a biological contaminant in a human patient, said method comprising:
determining at least one characteristic frequency of said biological contaminant;
determining at least one characteristic frequency of normal cells obtained from said human patient, wherein said at least one characteristic frequency of normal cells is not the same as said at least one characteristic frequency of said biological contaminant;
applying to said human patient high-intensity corrective sound waves based on said at least one characteristic frequency of said biological contaminant for a time sufficient to reduce the level of said biological contaminant in said human.

9. The method according to claim 8, further comprising the steps of:
determining the alignment of at least one desired magnetic field; and
positioning said human patient in a predetermined arrangement with respect to said alignment prior to said applying step.

10. The method according to claim 8, wherein said biological contaminant comprises at least one active virus.

11. The method according to claim 8, wherein said biological contaminant comprises neoplastic cells.

12. The method according to claim 8, wherein said at least one characteristic frequency of said biological contaminant is in the range of from 1 GHz to 300 GHz.
